(19) United States
(12) Patent Application Publication
(10) Pub. No.: US 2009/0303530 A1
(43) Pub. Date: Dec. 10, 2009

(54) Image processing apparatus and image processing method

(75) Inventors: Tomoyuki Honma, Osaka-shi (JP); Takahisa Mitsuyama, Osaka-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka-shi (JP)

(21) Appl. No.: 12/457,140

(22) Filed: Jun. 2, 2009

(30) Foreign Application Priority Data
Jun. 4, 2008 (JP) JP2008-146757

(51) Int. Cl. G06F 3/12

(52) U.S. Cl. 358/1.15

(57) ABSTRACT

The image processing apparatus has a confidential printing function of saving image data transmitted from an information processing apparatus once to perform printing in accordance with print instruction given by predetermined operation input to the image processing apparatus. When print instruction for the image data saved in the image processing apparatus is given, output characteristics comparing portions compare output characteristics of the image processing apparatus at the time when the image data was saved with output characteristics of the image processing apparatus at the time when print instruction was given. If it is determined that there is a difference of a predetermined value or more between the compared output characteristics, the image processing apparatus regenerates image data to be printed based on the output characteristics of the image processing apparatus at the time when printing was instructed.

### CROSS-NOTING PARAGRAPH

This Non-provisional application claims priority under 35 U.S.C. §119 (a) on Patent Application No. 2008-146757 filed in JAPAN on Jun. 4, 2008, the entire contents of which are hereby incorporated herein by reference.

### FIELD OF THE INVENTION

The present invention relates to an image processing apparatus and an image processing method, more specifically, to an image processing apparatus and an image processing method capable of obtaining a print result in which a color is unchanged even in a case where output characteristics at the time of generating an image are different from output characteristics at the time of printing in confidential printing, and to an image processing apparatus and an image processing method in which print information saved in the image processing apparatus is printed in a color tone desired by a user.

### BACKGROUND OF THE INVENTION

In recent years, a technology of “confidential printing” is being widespread, in which, when printing a document by an image processing apparatus such as a printer, image data to be printed is once saved in a main body of the printer with a password and is printed after the password is released on the printer. Although the image data generated in accordance with output characteristics of a toner of the printer is saved in this case, the output characteristics of the toner may be changed depending on the environment, time and a toner remaining amount, and therefore, there is a case where the output characteristics are changed by the time when printing is performed after the image data was generated and the print result of the image data has a different color from the one desired by a user.

In a case where a print job is saved in the printer without printing, the print job that is converted into the image data is saved in an HDD of the printer. In such a case, when converting the print job into the image data, the conversion is performed in consideration of the output characteristics of the printer in a printer driver of an information processing apparatus (PC).

Japanese Laid-Open Patent Publication No. 5-14683 discloses an image processing apparatus in which even a binary printer apparatus performs determination processing of determining whether or not a specific original is present based on image data by a single judging unit to prevent copying of a specific original or printing of specific image data input from an external device such as a computer. Japanese Laid-Open Patent Publication No. 5-14683 shows that color information of an output image transmitted from the computer is registered.

In Japanese Laid-Open Patent Publication No. 5-14683, the output characteristics in confidential printing are not considered, and there is a possibility that a desired print result is not obtained in a case where the output characteristics when image data was generated at the time of first printing are different from the output characteristics when image data is output at the time of reprinting.

For example, since the output characteristics of the image processing apparatus such as a printer are dynamically changed depending on the time/usage status, the output characteristics at the time of printing the saved print job and the output characteristics at the time of converting the print job into the image data do not necessarily coincide with each other in many cases. As a result, there is a problem that the color becomes different when printing the saved print job.

Further, Japanese Laid-Open Patent Publication No. 5-14683 is to judge the registered color information and the color of the image output from the computer but not to perform image adjustment for the output image.

### SUMMARY OF THE INVENTION

An object of the present invention is to provide an image processing apparatus and an image processing method capable of preventing that, when printing image data once saved in the image processing apparatus in accordance with subsequent operation input, a color of a printed matter becomes different or a printed matter having a different color is output due to a change in output characteristics between at the time of saving and at the time of printing.

Another object of the present invention is to provide an image processing apparatus having a function of printing image data saved in the image processing apparatus in accordance with print instruction given by predetermined operation input to the image processing apparatus, comprising: output characteristics comparing means for comparing, when print instruction for the image data saved in the image processing apparatus is given, output characteristics to which a characteristics value to be used for printing is set, the output characteristics comparing means comparing output characteristics of the image processing apparatus when the image data was saved with output characteristics of the image processing apparatus when the print instruction was given, wherein when it is determined from a result of comparison by the output characteristics comparing means that there is a difference of a predetermined value or more in the compared output characteristics, image data to be printed is regenerated based on the output characteristics of the image processing apparatus when the printing was instructed.

Another object of the present invention is to provide the image processing apparatus, wherein the output characteristics comparing means compares the output characteristics in a case where a predetermined time or more has passed from a point when the image data was saved in the image processing apparatus to a point when the printing was executed.

Another object of the present invention is to provide the image processing apparatus, wherein the output characteristics comparing means compares the output characteristics in a case where a predetermined amount or more of toner has been used for printing from a point when the image data was saved in the image processing apparatus to a point when the printing was executed.

Another object of the present invention is to provide the image processing apparatus having a function of performing printing with a plurality of colors of toner, wherein when the output characteristics comparing means compares output characteristics and even a single color has a difference of a predetermined value or more in output characteristics among output characteristics corresponding to each of the plurality of colors of toner, processing of regenerating the image data to be printed is performed, the image data to be regenerated being image data corresponding to a toner having a difference of a predetermined value or more in the output characteristics.

Another object of the present invention is to provide the image processing apparatus having a function of performing printing with a plurality of colors of toner, wherein when the output characteristics comparing means compares the output characteristics and even a single color has a difference of a predetermined value or more in output characteristics among output characteristics corresponding to each of the plurality of colors of toner, processing of regenerating the image data to be printed is performed, the image data to be regenerated being all image data corresponding to all toners.

Another object of the present invention is to provide an image processing method executed by an image processing apparatus having a function of printing image data saved in the image processing apparatus in accordance with print instruction given by predetermined operation input to the image processing apparatus, comprising: an output characteristics comparing step of comparing, when print instruction for the image data saved in the image processing apparatus is given, output characteristics of the image processing apparatus when the image data was saved with output characteristics of the image processing apparatus when the print instruction was given with respect to output characteristics to which a characteristics value to be used for printing is set; and a step of regenerating image data to be printed based on the output characteristics of the image processing apparatus when the printing was instructed in a case where it is determined from a result of comparison at the output characteristics comparing step that there is a difference of a predetermined value or more in the compared output characteristics.

Another object of the present invention is to provide an image processing apparatus having a function of printing image data saved in the image processing apparatus in accordance with print instruction given by predetermined operation input to the image processing apparatus, wherein when print instruction for the image data saved in the image processing apparatus is given, whether to print only a part of pages of the image data or to print all pages of the image data is decided based on a change in a predetermined characteristic amount from a point when the image data was saved to a point when the print instruction was given.

Another object of the present invention is to provide the image processing apparatus having a period calculating portion that calculates a saved period of the image data from a point when the image data was saved to a point when the print instruction was given, wherein the saved period calculated by the period calculating portion is used as the characteristic amount, and only a part of pages of the image data is printed in a case where the saved period exceeds a period previously set in the image processing apparatus, and all pages of the image data are printed in the case of not exceeding.

Another object of the present invention is to provide the image processing apparatus, wherein a change amount in a predetermined usage status of the image processing apparatus from a point when the image data was saved to a point when the print instruction was given is used as the characteristic amount, and only a part of pages of the image data is printed in a case where the change amount in the usage status exceeds a set value previously set in the image processing apparatus, and all pages of the image data are printed in the case of not exceeding.

Another object of the present invention is to provide the image processing apparatus, wherein the change amount in the usage status is a change amount in a toner remaining amount of the image processing apparatus.

Another object of the present invention is to provide the image processing apparatus, wherein the change amount in the usage status is a change amount in temperature in a place where the image processing apparatus is installed.

Another object of the present invention is to provide the image processing apparatus, wherein the change amount in the usage status is a change amount in humidity in a place where the image processing apparatus is installed.

Another object of the present invention is to provide the image processing apparatus, wherein a part of pages of the image data is a first page of the image data.

Another object of the present invention is to provide an image processing method executed by an image processing apparatus having a function of printing image data saved in the image processing apparatus in accordance with print instruction given by predetermined operation input to the image processing apparatus, comprising: a step of detecting, when print instruction for the image data saved in the image processing apparatus is given, a change in a predetermined characteristic amount from a point when the image data was saved to a point when the print instruction was given; and a step of deciding whether to print only a front cover page of the image data or to print all pages of the image data based on the detected change in the characteristic amount.

### BRIEF DESCRIPTION OF THE DRAWINGS

FIG. 1 is a diagram for explaining a state where image processing apparatuses applicable to the present invention are connected to a local network;

FIG. 2 is a diagram for explaining an exemplary apparatus configuration of information processing apparatuses and the image processing apparatuses shown in FIG. 1 more specifically;

FIG. 3 is a diagram for showing an exemplary display of a user I/F portion of the information processing apparatus;

FIG. 4 is a diagram for showing an example of a gamma table of the image processing apparatus;

FIGS. 5A and 5B are diagrams for explaining processing of comparing two types of output characteristics;

FIG. 6 is a diagram for showing a setting example of comparison standards of output characteristics in an output characteristics comparing portion of the image processing apparatus;

FIGS. 7A to 7C are diagrams for showing an exemplary display of a user I/F portion of the image processing apparatus;

FIG. 8 is a flowchart for explaining exemplary processing of instructing confidential printing in the information processing apparatus;

FIG. 9 is a flowchart for explaining exemplary processing of the image processing apparatus that has received print data transmitted from the information processing apparatus by the processing of FIG. 8;

FIG. 10 is a flowchart for explaining another exemplary processing of instructing confidential printing in the information processing apparatus;

FIG. 11 is a flowchart for explaining exemplary processing of the image processing apparatus that has received print data transmitted from the information processing apparatus by the processing of FIG. 10;

FIG. 12 is a flowchart for explaining exemplary processing in a case where confidential printing is instructed in the image processing apparatuses;

FIG. 13 is a flowchart for explaining exemplary processing when comparing two types of output characteristics in the image processing apparatuses;

FIG. 14 is a diagram for explaining another exemplary apparatus configuration of the information processing apparatus and the image processing apparatus more specifically;

FIG. 15 is a diagram for explaining still another exemplary apparatus configuration of the information processing apparatus and the image processing apparatus more specifically;

FIG. 16 is a diagram for showing an exemplary display screen when setting hold printing;

FIG. 17 is a diagram for showing an exemplary display screen when setting a password to print data;

FIG. 18 is a diagram for showing a setting example of a time stamp when image data was held and a period in which a print restriction is imposed;

FIG. 19 is a diagram for explaining an example of a restriction setting for detecting whether or not a using situation when image data was held and a using situation at present are largely changed;

FIG. 20 is a diagram for showing an example of output characteristics concerning color information stored in an output characteristics storage portion;

FIG. 21 is a diagram for showing an exemplary display screen for giving print instruction in the image processing apparatus;

FIG. 22 is a diagram for showing an exemplary display screen for setting hold printing in the image processing apparatus;

FIG. 23 is a diagram for showing an exemplary display screen for requesting input of a password in the image processing apparatus;

FIG. 24 is a diagram for showing an exemplary display screen when specifying a printing method in the image processing apparatus;

FIG. 25 is a diagram for showing an exemplary display screen that is displayed to confirm that confirmation printing has been performed in the image processing apparatus;

FIG. 26 is a diagram for showing an exemplary display screen for setting confirmation printing to be valid/invalid that has been performed in the image processing apparatus;

FIG. 27 is a diagram for showing an exemplary display screen for performing a restriction setting of a toner remaining amount in the image processing apparatus;

FIG. 28 is a diagram for showing an exemplary display screen for performing a restriction setting of a print restricted period in the image processing apparatus;

FIG. 29 is a flowchart for explaining an example of processing when printing is instructed in the information processing apparatus;

FIG. 30 is a flowchart for explaining another example of processing when printing is instructed in the information processing apparatus;

FIG. 31 is a flowchart for explaining an example of hold processing when the image processing apparatus receives print data from the information processing apparatus;

FIG. 32 is a flowchart for explaining another example of hold processing when the image processing apparatus receives print data from the information processing apparatus;

FIG. 33 is a flowchart for explaining an example of printing processing of held data in a case where confirmation printing is previously set to be valid in the image processing apparatuses; and

FIG. 34 is a flowchart for explaining an example of printing processing of held data in a case where confirmation printing is previously set to be invalid in the image processing apparatuses.

### PREFERRED EMBODIMENTS OF THE INVENTION

In an embodiment of an image processing apparatus according to the present invention, when a user instructs printing for image data (C (cyan), M (magenta), Y (yellow), and Bk (black)) that is saved in a printable state in the image processing apparatus by confidential printing processing and the like, if it is determined that a difference between output characteristics of the image processing apparatus at the time of saving the image data and output characteristics of the image processing apparatus at the time of instructing printing is equal to or more than a predetermined value, the image data is regenerated based on the output characteristics of the image processing apparatus at the time of instructing printing. This makes it possible to prevent that a color of a printed matter becomes different from a desired color even after a long time has passed since the saving of the image data.

Further, in another embodiment of the image processing apparatus according to the present invention, a period calculating portion is provided to calculate a saved period from a point when the image data was saved to a point when the user instructed printing at the time of printing the image data once saved in the image processing apparatus, and a part of specified pages of the image data, for example, only a front cover page is printed in a case where the calculated saved period exceeds a period previously set in the image processing apparatus, and all of the pages are printed in the case of not exceeding. This configuration enables to prevent that a printed matter is output with a color not desired by the user because of leaving data without printing for a long time.

Embodiments according to the present invention will hereinafter be described in detail referring to the accompanying drawings.

### Embodiment 1

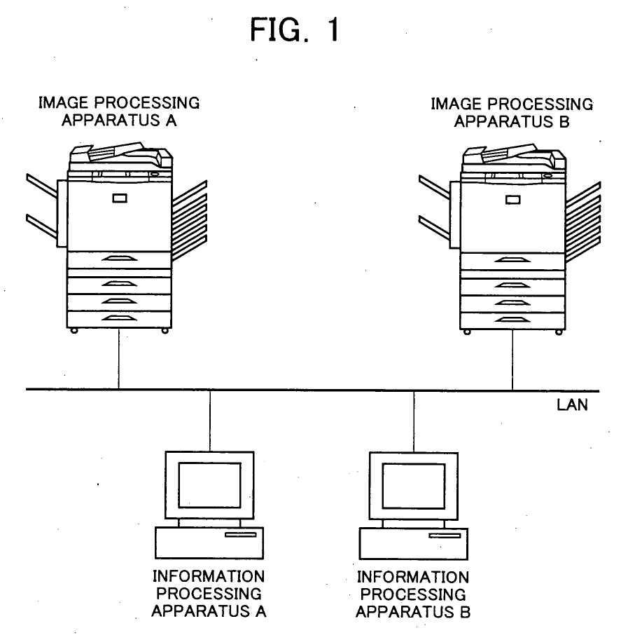

FIG. 1 is a diagram for explaining a state where image processing apparatuses applicable to the present invention are connected to a local network. Image processing apparatuses A and B are connected to information processing apparatuses A and B each other through a local area network (LAN) which is a network.

Here, the image processing apparatus A and the information processing apparatus A perform printing by transmitting print data generated with the use of a printer language from the information processing apparatus A to the image processing apparatus A to generate image data to be printed by the image processing apparatus A.

Further, the image processing apparatus B and the information processing apparatus B perform printing by transmitting print data including image data to the image processing apparatus B by the information processing apparatus B to extract the image data from the print data by the image processing apparatus B.

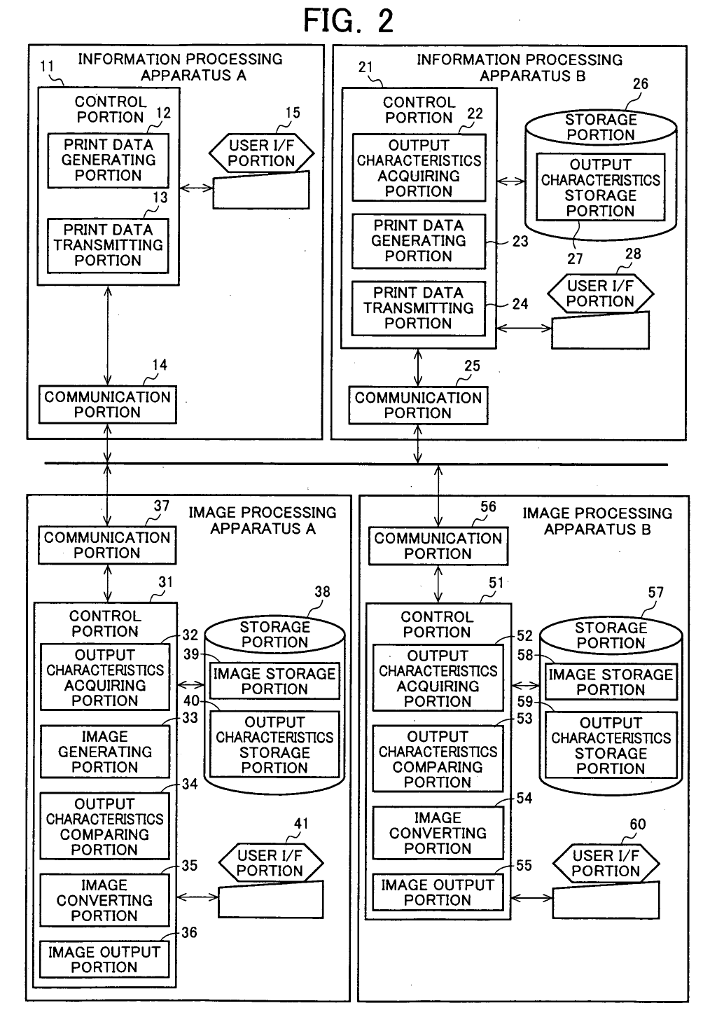

FIG. 2 is a diagram for explaining an exemplary apparatus configuration of the information processing apparatuses and the image processing apparatuses shown in FIG. 1 more specifically. The information processing apparatus A includes a control portion 11, a communication portion 14, and a user I/F portion 15. The control portion 11 includes a print data generating portion 12 and a print data transmitting portion 13.

In a case where printing of a document is instructed, the print data generating portion 12 generates print data for printing the specified document by the image processing apparatus A. The print data transmitting portion 13 transmits the print data generated by the print data generating portion 12 to the image processing apparatus A through the communication portion 14.

The communication portion 14 communicatively connects the information processing apparatus A, the information processing apparatus B, and the image processing apparatuses A and B through a network such as a LAN.

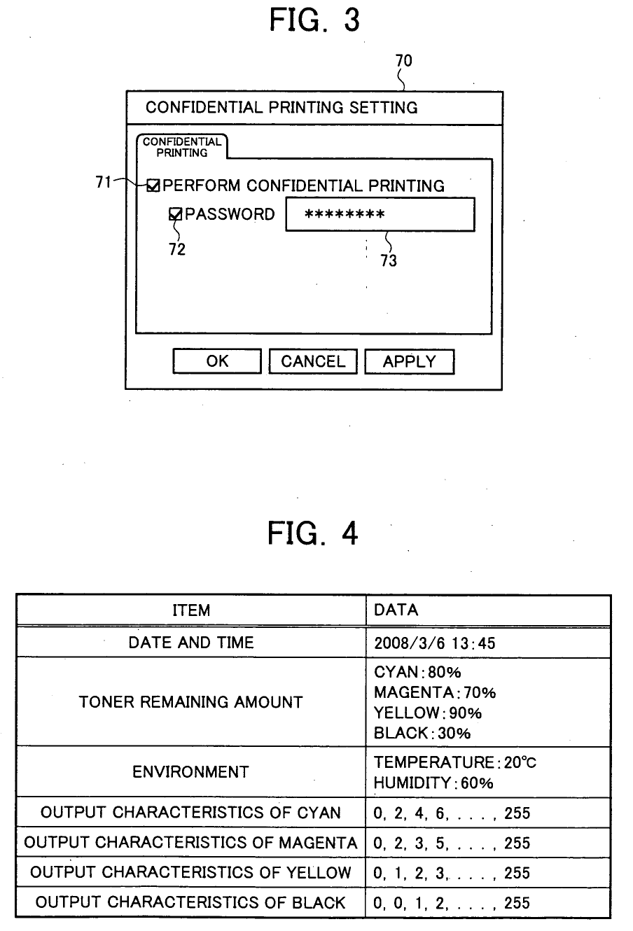

The user I/F portion 15 is for a user to perform a setting of printing and confidential printing. For example, FIG. 3 is a diagram for showing an exemplary display screen of the user I/F portion 15. The display screen 70 is provided with a check box 71 for setting whether or not confidential printing is performed, a check box 72 for setting whether or not a password is set, and a password input column 73 for inputting a password character string.

One type of the confidential printing enables a setting of hold printing in which the image processing apparatus is caused to hold image data without setting a password. In confidential printing processing where a password is set, when printing image data once held by the image processing apparatus, operation input of print instruction and a password is performed to the image processing apparatus. Further, in the hold printing where no password is required, operation input of print instruction is performed to the image processing apparatus in order to print image data once held by the image processing apparatus.

The image processing apparatus A includes a control portion 31, a communication portion 37, a storage portion 38, and a user I/F portion 41 as shown in FIG. 2. The control portion 31 includes an output characteristics acquiring portion 32, an image generating portion 33, an output characteristics comparing portion 34, an image converting portion 35, and an image output portion 36. The storage portion 38 includes an image storage portion 39 and an output characteristics storage portion 40.

The output characteristics acquiring portion 32 of the image processing apparatus A acquires a gamma table of respective colors of the toner as current output characteristics of the image processing apparatus A.

FIG. 4 shows an example of a gamma table of the image processing apparatus. This gamma table shows an example of output characteristics of the present invention, where characteristics values to be used in printing are decided. Shown here are input pixel values necessary for outputting a pixel value for each of 256 stages from 0 to 255 with respect to colors of cyan, magenta, yellow, and black. For example, a gamma table (output characteristics) of cyan in FIG. 4 shows that input pixel values of 0, 2, 4, 6 and 255 are necessary to output 0, 1, 2, 3 and 255, respectively. Further, date and time/toner remaining amount/environment at the time when the output characteristics were generated are also stored. Here, each of toner remaining amounts of cyan, magenta, yellow, and black is stored as the toner remaining amount and temperature and humidity are stored as the environment.

The image generating portion 33 generates image data to be output from the print data received from the information processing apparatus A and regenerates image data based on the output characteristics acquired by the output characteristics acquiring portion 32.

The image storage portion 39 is storage means such as a ROM or a RAM and stores the image data generated by the image generating portion 33. The output characteristics storage portion 40 is storage means such as a ROM or a RAM and stores the output characteristics as shown in FIG. 4 acquired by the output characteristics acquiring portion 32.

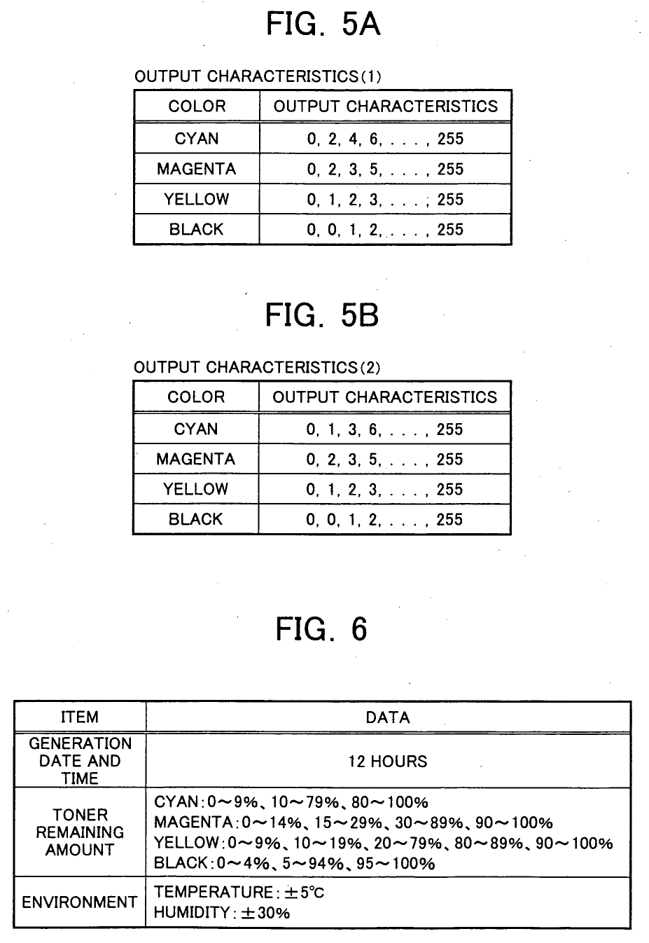

The output characteristics comparing portion 34 compares the output characteristics stored in the output characteristics storage portion 40 with the output characteristics acquired by the output characteristics acquiring portion 32. For example, in a case where there are two types of output characteristics as shown in FIGS. 5A and 5B, output characteristics of magenta, yellow, and black are determined as the same since all of the values thereof are the same. In addition, each of the output characteristics of cyan is “0, 2, 4, 6, . . . , 255” and “0, 1, 3, 6, . . . , 255”, where the second value and the third value are different. In such a case, if even a single value is different, it may be determined that the output characteristics are different or it may be determined with the standard set such that the output characteristics are different when 5% of the whole are different.

Moreover, when comparing the output characteristics as described above, the standard of whether or not the comparison of the output characteristics is performed may be set as shown in FIG. 6. In FIG. 6, the standards are set in accordance with “generation date and time”, “toner remaining amount”, and “environment” of output characteristics at the time of generating image data and output characteristics at present, and the comparison of the output characteristics is performed in a case where all of the standards are satisfied.

For example, the standard of the generation date and time is set to twelve hours in FIG. 6 so that the comparison of the output characteristics is performed in a case where a difference between the generation date and time of the output characteristics at the time of generating image data (that is, at the time when the image data was saved in the image processing apparatus) and the date and time at present when printing is executed is twelve hours or more.

In addition, a category may be set like in the standard of the toner remaining amount of FIG. 6. In FIG. 6, the toner remaining amount of cyan is categorized into 0 to 9%, 10 to 79%, and 80 to 100%. In a case where the toner remaining amount of cyan at the time of generating image data is 95% and the current toner remaining amount of cyan is 80%, these toner remaining amounts belong to the same category and the comparison of the output characteristics is therefore not performed. In a case where the toner remaining amount of cyan at the time of generating image data is 95% and the current toner remaining amount of cyan is 79%, these toner remaining amounts belong to different categories and the comparison of the output characteristics is therefore performed.

In addition, temperature of ±5 degrees Celsius and humidity of ±30% are set as the standard of the environment in FIG. 6. In accordance with the standard, when a difference between the temperature and humidity at the time of generating image data and temperature and humidity at present exceeds the standard, the comparison of the output characteristics is performed.

That is, in this example, in a case where the time from a point when the image data was saved in the image processing apparatus A to a point when printing is executed is equal to or more than a predetermined time, the output characteristics comparing portion 34 (output characteristics comparing means) performs the comparison of the output characteristics. Further, in a case where a predetermined amount or more of the toner used for printing has been used until printing is executed after the image data was saved in the image processing apparatus A, the output characteristics comparing portion 34 performs the comparison of the output characteristics. Whether or not the output characteristics are compared may be determined only by the above-described time conditions, by the used amount of the toner, or by both of them.

The image converting portion 35 regenerates image data based on the current output characteristics with respect to the image data stored in the image storage portion 39. For example, in the case of image data in consideration of output characteristics in the image storage portion 39, influence of the output characteristics is removed and thereafter the regeneration is performed based on the current output characteristics.

The image output portion 36 performs printing of the image data stored in the image storage portion 39 or the image data regenerated by the image converting portion 35.

The communication portion 37 communicatively connects the image processing apparatus A to the information processing apparatuses A and B, and the image processing apparatus B through a network such as a LAN.

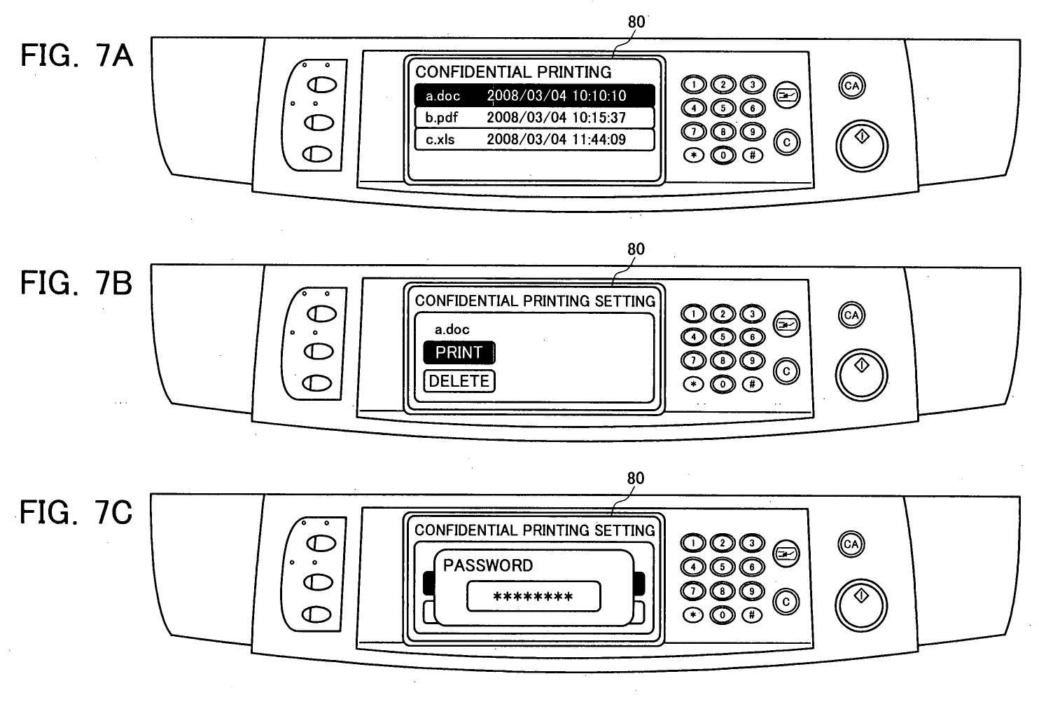

The user I/F portion 41 is a user I/F such as a touch panel display that is disposed on the image processing apparatus and enables a user to specify a confidential printing function. FIGS. 7A to 7C show an exemplary display of a touch panel display 80 that functions as a user I/F of the image processing apparatus. For example, when a user performs confidential printing, a list of print jobs registered as confidential printing is displayed on a display screen 80 that is provided on an operation portion of the image processing apparatus as shown in FIG. 7A. When the user selects “a. doc” in FIG. 7A, a list of processing that can be performed for the selected print job is displayed as shown in FIG. 7B. When the user selects “print” in FIG. 7B, the print job is printed. In a case where a password is set by the user I/F portion 15 of the information processing apparatus as shown in FIG. 3, the input of a password is prompted on the screen as shown in FIG. 7C and the processing may be performed only when the password is matched.

The information processing apparatus B includes a control portion 21, a communication portion 25, a storage portion 26, and a user I/F portion 28 as shown in FIG. 2. The control portion 21 includes an output characteristics acquiring portion 22, a print data generating portion 23, and a print data transmitting portion 24. The storage portion 26 includes an output characteristics storage portion 27.

The output characteristics acquiring portion 22 acquires through the communication portion 25 a gamma table of respective colors of the toner as the current output characteristics of the image processing apparatus B as shown in FIG. 4. The acquisition processing may be performed every time of printing or only when instructed by the user. The acquisition may be also performed regularly.

The output characteristics storage portion 27 is storage means such as a ROM or a RAM and stores output characteristics as shown in FIG. 4 acquired by the output characteristics acquiring portion 22.

In a case where printing of a document is instructed, the print data generating portion 23 generates print data for printing the specified document by the image processing apparatus B. At this time, the print data is generated in accordance with the output characteristics stored in the output characteristics storage portion 27.

The print data transmitting portion 24 transmits the print data generated by the print data generating portion 23 and the output characteristics stored in the output characteristics storage portion 27 to the image processing apparatus B through the communication portion 25.

The user I/F portion 28 allows the user to perform a setting of printing and a setting of confidential printing as shown in FIG. 3 and is like a touch panel display, for example.

The communication portion 25 communicatively connects the information processing apparatus B to the information processing apparatus A, and the image processing apparatuses A and B through a network such as a LAN.

The image processing apparatus B includes a control portion 51, a communication portion 56, a storage portion 57, and a user I/F portion 60 as shown in FIG. 2. The control portion 51 includes an output characteristics acquiring portion 52, an output characteristics comparing portion 53, an image converting portion 54, and an image output portion 55. The storage portion 57 includes an image storage portion 58 and an output characteristics storage portion 59.

The output characteristics acquiring portion 52 acquires a gamma table of respective colors of the toner as current output characteristics of the image processing apparatus B.

The image storage portion 58 is storage means such as a ROM or a RAM and stores the image data received from the information processing apparatus B.

The output characteristics storage portion 59 is storage means such as a ROM or a RAM and stores the output characteristics received from the information processing apparatus B.

The output characteristics comparing portion 53 compares the output characteristics stored in the output characteristics storage portion 59 with the output characteristics acquired by the output characteristics acquiring portion 52.

The image converting portion 54 regenerates image data based on the current output characteristics with respect to the image data stored in the image storage portion 58.

The image output portion 55 performs printing of the image data stored in the image storage portion 58 or the image data regenerated by the image converting portion 54.

The communication portion 56 communicatively connects the image processing apparatus B to the information processing apparatuses A and B and the image processing apparatus A through a network such as a LAN.

Only the image processing apparatus like the information processing apparatus A and the image processing apparatus A may store the output characteristics to generate image data or the information processing apparatus like the information processing apparatus B and the image processing apparatus B may acquire the output characteristics of the image processing apparatus to generate image data.

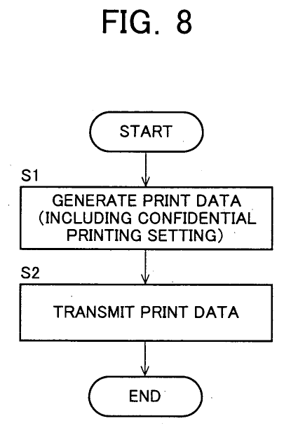

Flowcharts of FIGS. 8 to 12 show exemplary processing of the image processing apparatuses and the information processing apparatuses concerning this embodiment.

FIG. 8 shows exemplary processing of instructing confidential printing in the information processing apparatus A. When a setting of confidential printing is performed by the user I/F portion 15 of the information processing apparatus A and a start of printing is instructed, print data to be printed on the side of the image processing apparatus is firstly generated (step S1). The print data also includes a setting of confidential printing such as ON/OFF of confidential printing and a password for confidential printing in addition to information of a document to be printed. Subsequently, the information processing apparatus A transmits the generated print data to the image processing apparatus (step S2) to finish the processing.

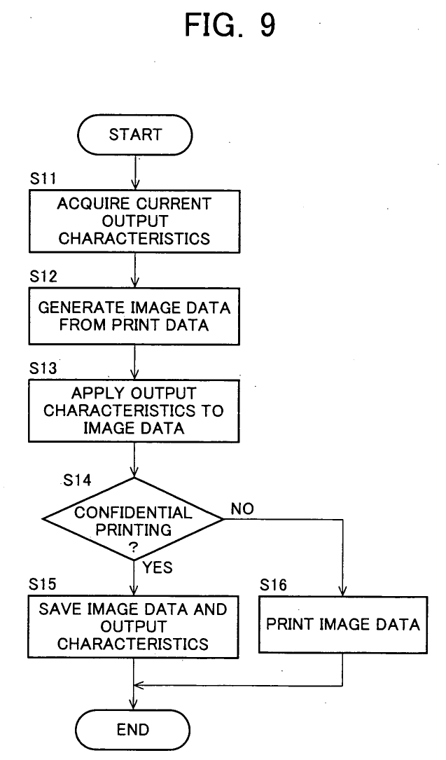

FIG. 9 shows exemplary processing of the image processing apparatus A that has received the print data transmitted from the information processing apparatus A by the processing of FIG. 8. First, the current output characteristics of the image processing apparatus A are acquired (step S11) and image data to be printed is generated based on the print data (PDL data) received by the image processing apparatus A (step S12).

Subsequently, an image is generated based on the output characteristics acquired at step S11 with respect to each of pixels of the image data generated at step S12 (step S13). For example, in a case where the current output characteristics have the characteristics shown in FIG. 4, if a cyan value of a certain pixel in the image generated at step S12 is 0, 1, 2, 3, and 255, the value of the pixel is changed into 0, 2, 4, 6, and 255, respectively.

Then, the image processing apparatus A determines whether confidential printing of the print data received from the information processing apparatus A is instructed (step S14), and when confidential printing is instructed, the image data regenerated at step S13 and the output characteristics acquired at step S11 are saved (step S15) to finish the processing. When confidential printing is not instructed, the image data regenerated at step S16 is output.

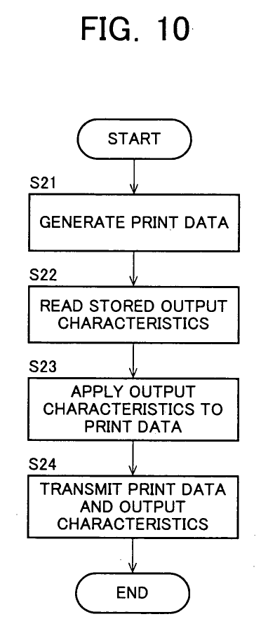

FIG. 10 shows exemplary processing of instructing confidential printing in the information processing apparatus B. When a setting of confidential printing is performed by the user I/F portion 28 on the side of the information processing apparatus B and a start of printing is instructed, print data (GDI (Graphics Device Interface) data) is generated in the information processing apparatus B (step S21). The print data also includes a setting of confidential printing such as ON/OFF of confidential printing and a password for confidential printing.

Subsequently, in the information processing apparatus B, the output characteristics that have been already acquired from the image processing apparatus B and saved is read (step S22). Alternatively, at this time, the output characteristics of the image processing apparatus B may be acquired every time of printing.

Subsequently, the output characteristics acquired at step S22 are applied to the print data generated at step S21 to generate print data (step S23). For example, in a case where the current output characteristics have the characteristics shown in FIG. 4, if a cyan value of a certain pixel in the image generated at step S12 is 0, 1, 2, 3, and 255, the value of the pixel is changed into 0, 2, 4, 6, and 255, respectively. Finally, the print data regenerated at step S23 and the output characteristics are transmitted to the image processing apparatus B (step S24) to finish the processing.

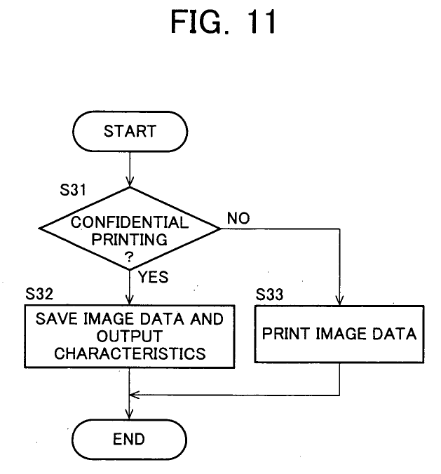

FIG. 11 shows exemplary processing of the image processing apparatus B that has received the print data transmitted from the information processing apparatus B by the processing of FIG. 10. First, the image processing apparatus B determines whether confidential printing of the print data received from the information processing apparatus B is instructed (step S31), and when confidential printing is instructed, image data extracted from the received print data and the output characteristics are saved (step S32). Alternatively, when confidential printing of the received print data is not instructed, image data extracted from the received print data is printed (step S33).

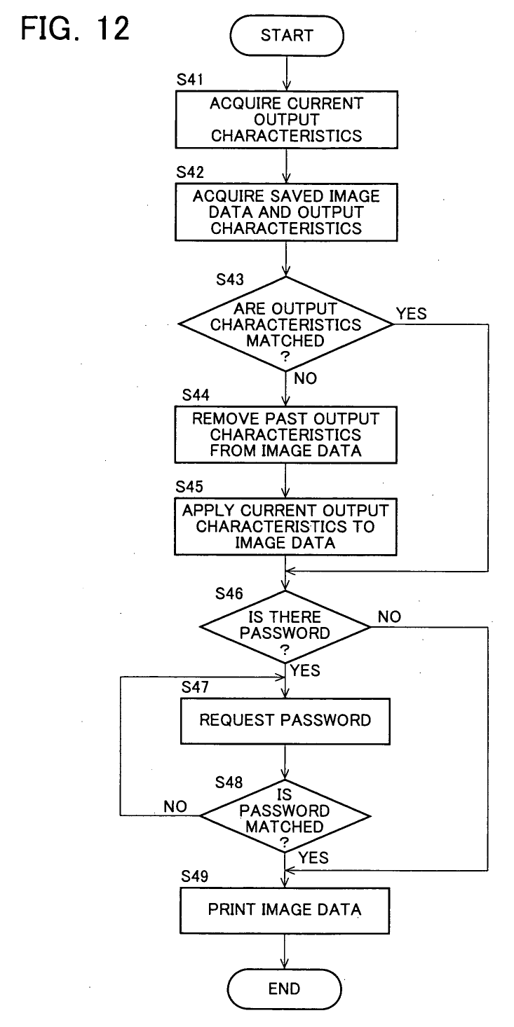

FIG. 12 shows exemplary processing in a case where confidential printing is instructed in the image processing apparatuses A and B. First, the current output characteristics of the image processing apparatus are acquired in the image processing apparatus (step S41) and the saved image data and the output characteristics are acquired (step S42). The saved image data and the output characteristics have been saved at step S15 of FIG. 9 (image processing apparatus A) or at step S32 of FIG. 11 (image processing apparatus B).

Then, the current output characteristics acquired at step and the output characteristics acquired at step S42 are compared (step S43), and when these output characteristics are matched, the procedure proceeds to step S46. Alternatively, when these output characteristics are not matched, the past output characteristics, that is, the output characteristics at the time of generating the image data are removed from the image data (step S44) to regenerate an image based on the current output characteristics. At this time, the current output characteristics are applied to the image data to reproduce the image (step S45).

Subsequently, whether a password is set for confidential printing is determined in the image processing apparatus (step S46), and when no password is set, the procedure proceeds to step S49. When a password is set, a screen for requesting a password as shown in FIG. 7C is displayed (step S47). When a password is input, whether the password is matched with a password that has been set (step S48), and when being not matched, the procedure returns to step S47. When being matched, the image data is printed (step S49).

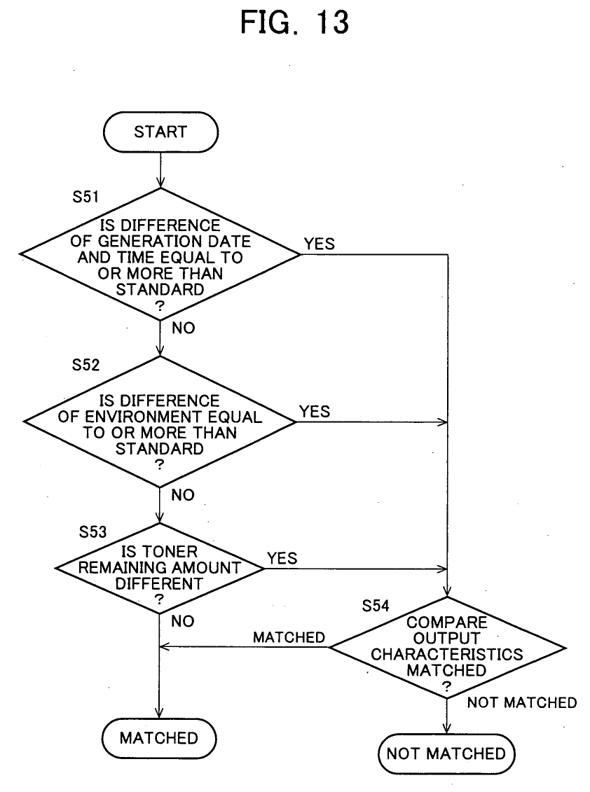

FIG. 13 shows exemplary processing when two types of output characteristics are compared in the image processing apparatuses A and B. In comparing the output characteristics, first, a difference of the generation date and time of both of the output characteristics is calculated to determine whether the difference is equal to or more than the standard of FIG. 6 (step S51). The output characteristics to be compared are the output characteristics at the time when the saved image data was generated and saved and the output characteristics at the time when printing was instructed to execute the printing. That is, the output characteristics comparing portion (means) compares the output characteristics at the time when the image data was saved in the image processing apparatus with the output characteristics at the time when printing was instructed to output the image data.

As a result of comparing the output characteristics, when the above-described difference of the generation date and time is equal to or more than the standard (equal to or more than a predetermined value), the procedure proceeds to step S54. Alternatively, when the difference of the generation date and time of the output characteristics is smaller than the standard, a difference of the environment (temperature and humidity) at the time when both of the output characteristics were generated (at the time of saving the image data and at the time of executing printing) to determine whether the difference is equal to or more than the standard of FIG. 6 (step S52). In the case of being equal to or more than the standard, the procedure proceeds to step S54. In this case, it may be determined that the difference of the environment is equal to or more than the standard when both differences between temperature and between humidity are equal to or more than the standard, or it may be determined that the difference of the environment is equal to or more than the standard when either one of differences between temperature and between humidity is equal to or more than the standard.

If it is determined that the difference of the environment is smaller than the standard, toner remaining amounts of respective colors at the time when both of the output characteristics were generated are classified into categories of FIG. 6 to determine whether the categories are different (step S53).

In a case where even a single color of cyan, magenta, yellow, and black has a different category of the toner remaining amount, the procedure proceeds to step S54. The case where all of the colors of toner remaining amounts have the same category is regarded as being matched to finish the processing without performing the comparison of the output characteristics. That is, in a case where the toner used for printing has been used a predetermined amount or more, the comparison of the output characteristics is performed. At step S54, the comparison of both of the output characteristics is performed to finish the processing.

In the processing of generating image data again after having compared the output characteristics, when the output characteristics comparing portion compares the output characteristics, if even a single color has a difference that is equal to or more than a predetermined value in the output characteristics among output characteristics corresponding to each of a plurality of colors of toners, it is possible to perform the processing of regenerating image data to be printed. At this time, the image data to be regenerated is allowed to be image data corresponding to the toner that has a difference equal to or more than a predetermined value in the output characteristics.

Alternatively, if even a single color has a difference that is equal to or more than a predetermined value in the output characteristics among output characteristics corresponding to each of a plurality of colors of toners, the image data to be regenerated may be all image data corresponding to all of the toners.

### Embodiment 2

Provided in an second embodiment of the present invention is the image processing apparatus in which image data generated based on print data transmitted from the information processing apparatus is saved in the image processing apparatus, and when the saved period has passed a predetermined period or when a usage status of the image processing apparatus is changed, a confirmation printing function is actuated and a previously specified page, for example, only a page is printed.

When saving image data, color characteristics of the image processing apparatus are saved together with the image data so as to enable printing in a previous color at the time of confirmation printing. It is also possible that, after the confirmation printing, the current color characteristics of the image processing apparatus are caused to be applied to the image data to perform printing. This makes it possible to reduce printing errors in a case where a color of a printed matter becomes different due to a change in the usage status of the image processing apparatus and long-time saving of print information.

The image processing apparatus according to this embodiment will be described referring to FIG. 1 of the above-described embodiment 1. As shown in the schematic view of FIG. 1, the information processing apparatuses A and B are connected to the image processing apparatuses A and B each other through a local area network (LAN) which is a network.

Similarly to the embodiment 1, in a case where printing is performed with the use of the information processing apparatus A and the image processing apparatus A as an existent technology, the information processing apparatus A generates print data by a printer description language based on document data and thereafter transmits the print data to the image processing apparatus A, and the image processing apparatus A generates image data (binary data) based on the print data to perform printing.

Moreover, in the case of performing printing with the use of the information processing apparatus B and the image processing apparatus B, the information processing apparatus B generates image data based on document data and transmits the image data as print data to the image processing apparatus B, and the image processing apparatus B extracts the image data from the print data to perform printing.

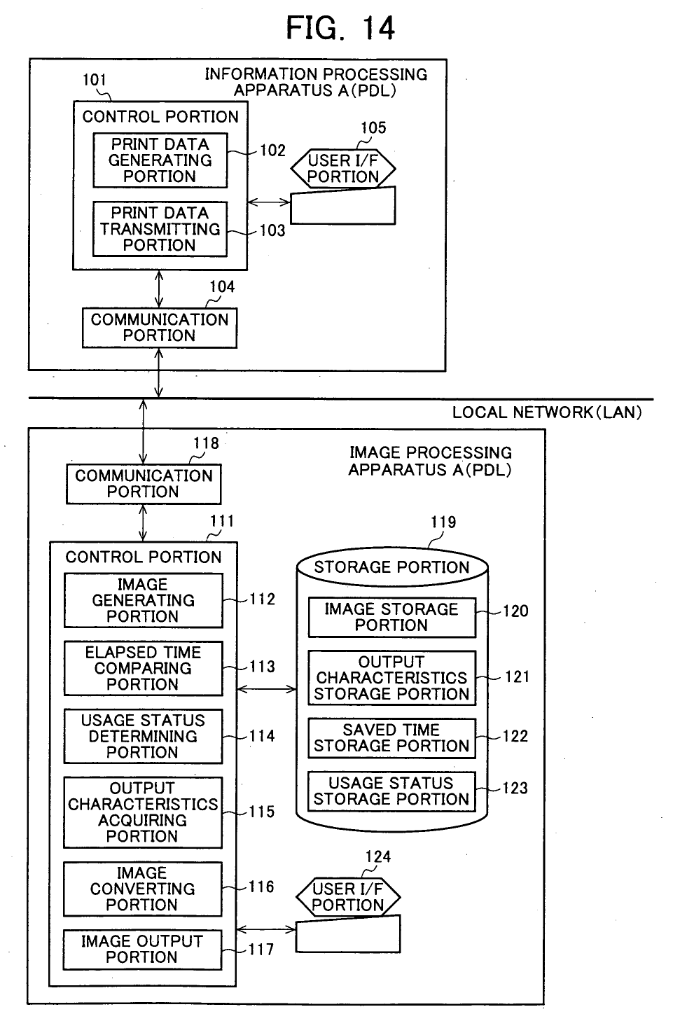

FIG. 14 is a diagram for explaining an exemplary apparatus configuration of the information processing apparatus and the image processing apparatus in this embodiment more specifically. The information processing apparatus A includes a control portion 101, a communication portion 104, and a user I/F portion 105. The control portion 101 includes a print data generating portion 102 and a print data transmitting portion 103.

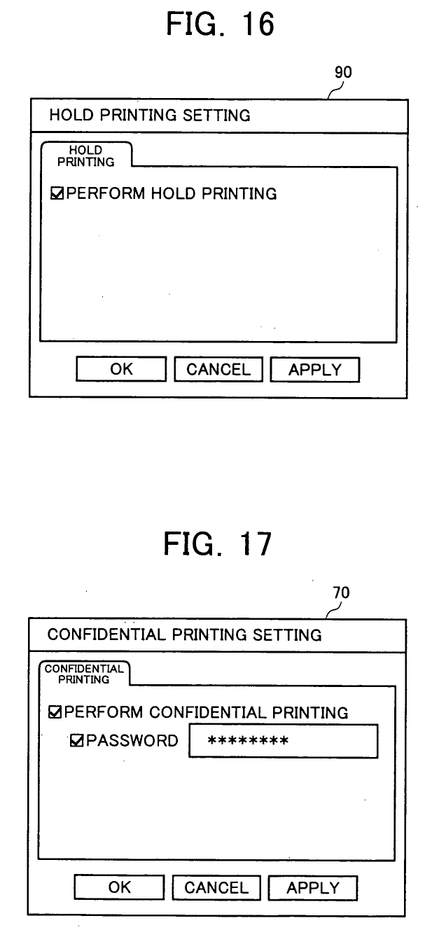

The user I/F portion 105 is a screen on which a user selects a printing setting of data to be printed (hereinafter referred to as document data) and is a mechanism for sending a print data generation command and a printing setting to the control portion 101. In a case where the user desires to save print data in the image processing apparatus without printing the print data by the image processing apparatus, it is possible to perform a setting of hold printing with the use of a display screen 90 as shown in FIG. 16. In this case, it is possible to cause the storage portion in the image processing apparatus to save the print data generated by the information processing apparatus.

In a case where the setting of hold printing is performed in the printing setting, it is also possible to set a password to the print data as shown on the display screen 70 of FIG. 17 and to protect the print data using the password. This processing is called confidential printing and is applicable in this embodiment to processing of causing the image processing apparatus to hold the image data once regardless of presence of the password and causing the image processing apparatus to print out the image data in accordance with predetermined operation input.

The communication portion 104 allows the image processing apparatus A and the information processing apparatus A to communicate with each other through a network such as a LAN and is capable of transmitting/receiving various data. A communication portion 118 similar to the communication portion 104 of the information processing apparatus A is also provided in the image processing apparatus A.

The control portion (information processing apparatus) of the information processing apparatus A generates print data and makes a command to transmit the print data based on a print command received from the user I/F portion 105.

The image processing apparatus A includes a control portion 111, the communication portion 118, a storage portion 119, and a user I/F portion 124 as shown in FIG. 14. The control portion 111 includes an image generating portion 112, an elapsed time comparing portion 113, a usage status determining portion 114, an output characteristics acquiring portion 115, an image converting portion 116, and an image output portion 117. The storage portion 119 includes an image storage portion 120, an output characteristics storage portion 121, a saved time storage portion 122, and a usage status storage portion 123.

The image storage portion 120 of the storage portion 119 saves (holds) image data.

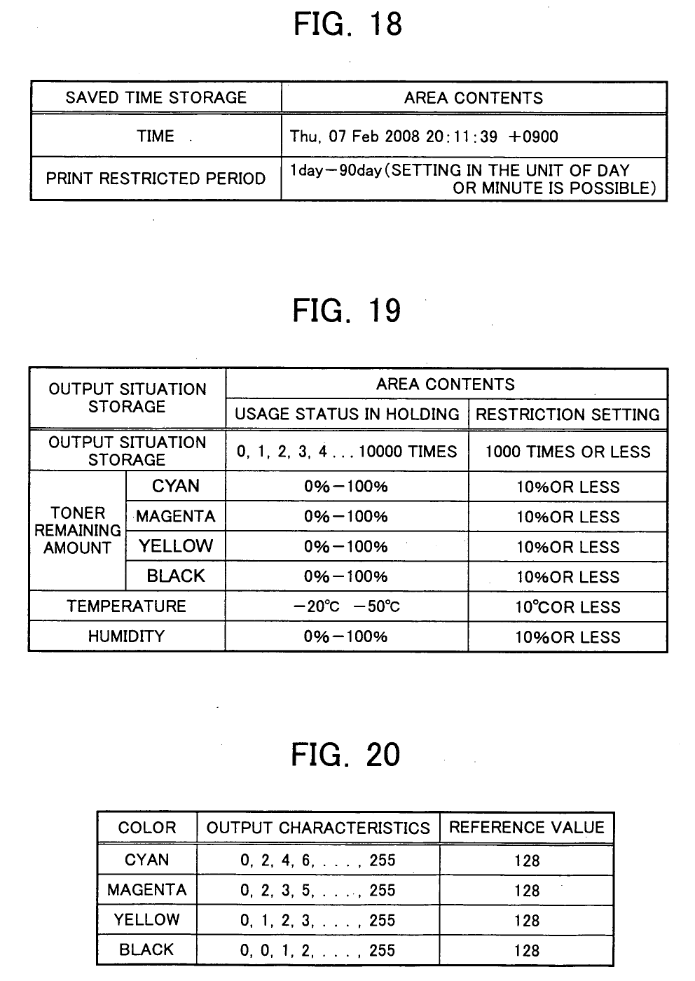

The saved time storage portion 122 saves a time stamp when the image data was held and a setting of a period in which a print restriction is imposed. For example, the time stamp and the print restricted period are saved in a format as shown in FIG. 18.

The usage status storage portion 123 saves the usage status of a printer such as the toner remaining amount at the time when image data was held and temperature and humidity at an installation position, and a restriction setting. The restriction setting is a parameter in which a restriction is set such that the confirmation printing is performed if the usage frequency or a change amount in the toner remaining amount is larger than the value. For example, as shown in FIG. 19, the number of times of printing another printed matter until then is saved as the usage frequency and a ratio of the toner remaining amount such as 50% is saved as the toner remaining amount.

The control portion 111 performs processing of generating image data, processing of saving image data, processing of calculating/comparing elapsed time, processing of determining a usage status, processing of acquiring output characteristics, processing of converting image data, and processing of outputting an image.

The image generating portion 112 performs the processing of generating and saving image data. The processing of generating image data is processing in which the output characteristics of the image processing apparatus are applied to print data to generate image data whose color tone is adjusted to be output most finely. The processing of saving image data is processing to save the image data in the image storage portion 120 of the storage portion 119.

The elapsed time comparing portion 113 performs the processing of calculating/comparing elapsed time. Elapsed time from a point when the image data was saved (held) to a current point is derived and the elapsed time and a print restricted period that has been set are compared to determine whether or not the elapsed time exceeds the print restricted period. The elapsed time comparing portion 113 corresponds to a period calculating portion of the present invention that calculates a saved period from a point when the image data was saved to a point when print instruction was given.

The usage status determining portion 114 performs the processing of determining the usage status of the image processing apparatus A. At the determination processing, whether or not a usage status when the image data was held and a current usage status are largely changed is detected. For example, in a case where the printing frequency at the time of holding the image data is 1000 times and the current printing frequency is 10000 times, a change amount in the printing frequency is an increase by 9000 times. When the value is collated with the restriction setting of FIG. 19, a limit value is 1000 times or less of output frequency (that is, printing frequency) in a list of restriction settings of FIG. 19. In the case of exceeding the limit value, it is determined that the usage status is changed. In the above-described example, a change amount in the output frequency is 1000 times or more, it is determined that the usage status is largely changed.

The output characteristics acquiring portion 115 performs the processing of acquiring output characteristics. This is processing to acquire the output characteristics of the image processing apparatus A that have been saved at the time of holding from the storage portion 119. The image converting portion 116 performs the processing of converting image data. This is processing to delete the past output characteristics from the image data and to apply the current output characteristics of the image processing apparatus to the image data.

The image output portion 117 performs the processing of outputting an image. It is determined whether to print a predetermined page, for example, only a page of the image data or to print all of the pages to perform printing. For example, an operation is performed such that if the usage status is largely changed when performing the processing of confirming the usage status, only a page of the image data is printed, and if it is determined that there is no large change, all of the pages are printed.

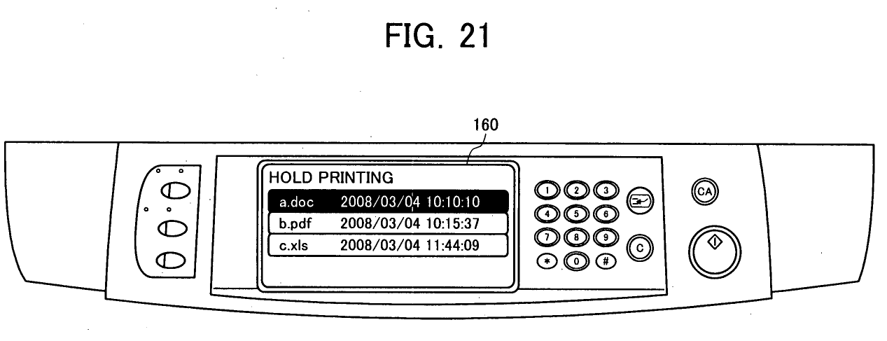

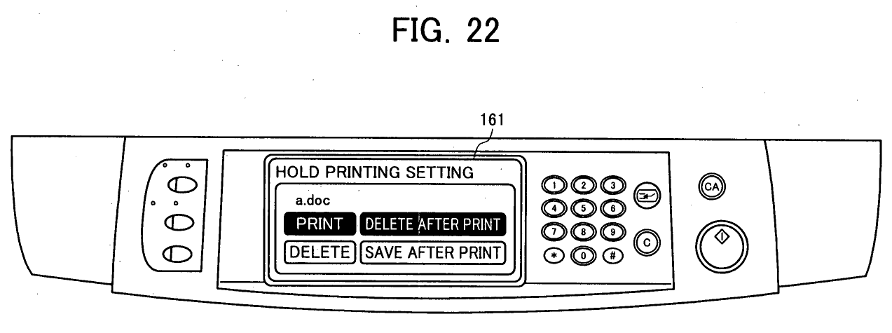

The user I/F portion 124 is an interface in which a user instructs printing from a display screen 160 as shown in FIG. 21 at the time of printing the held image data. In a case where the held image data is printed on the side of the image processing apparatus A, a list of print jobs as shown in FIG. 21 is firstly displayed on the display screen 160. When the user selects one of the displayed jobs, the display is shifted to a display screen 161 as shown in FIG. 22. When “a. doc” is selected on the display screen 160 of FIG. 21, the display screen 161 of FIG. 22 enables selection of printing or deleting of the held image data. In a case where the user selects print, whether to delete or save the data after print is selectable.

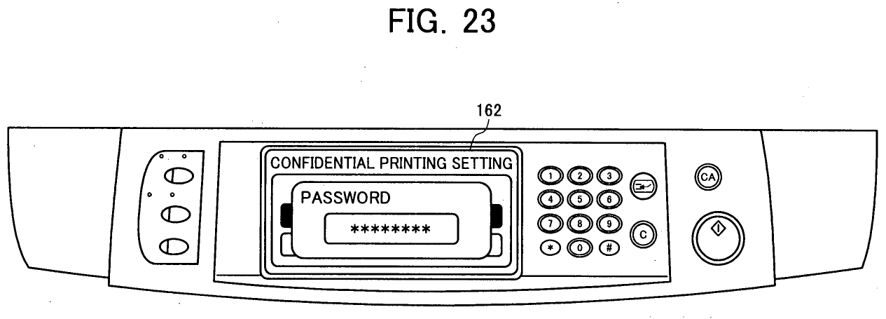

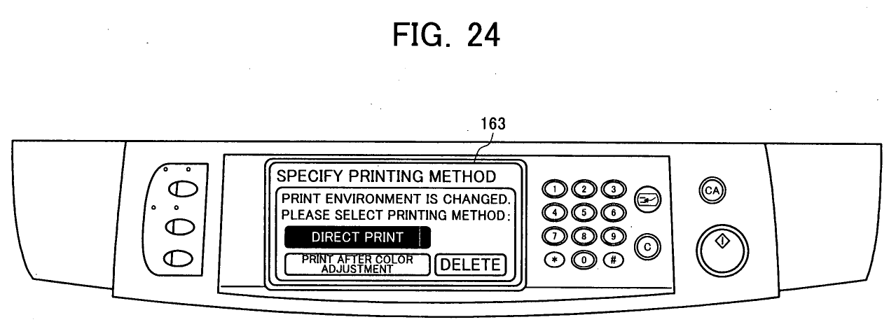

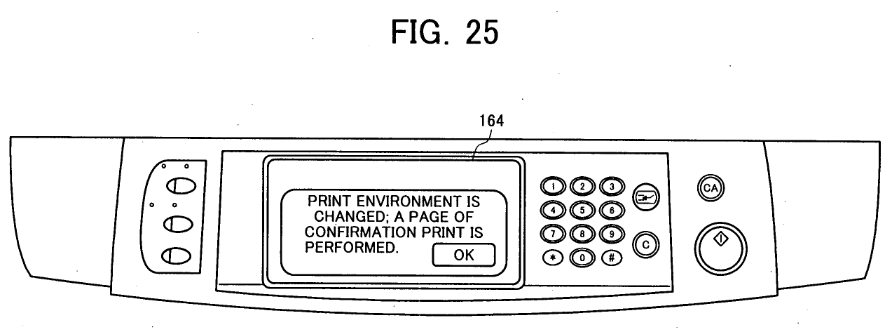

In a case where confidential printing is set to print data in the information processing apparatus A, a password is requested on the display screen 162 as shown in FIG. 23 before printing. In a case where the confirmation printing is automatically executed based on the usage status of the image processing apparatus A and the elapsed time after holding, the user is prompted to confirm whether a printed matter is output in a correct color on the display screen 163 as shown in FIG. 24. When “direct print” is selected here, the specified image data is directly printed without performing the confirmation printing, and when “print after color adjustment” is selected, the confirmation printing for a page or the like is performed and a display screen 164 for confirmation is displayed as shown in FIG. 25.

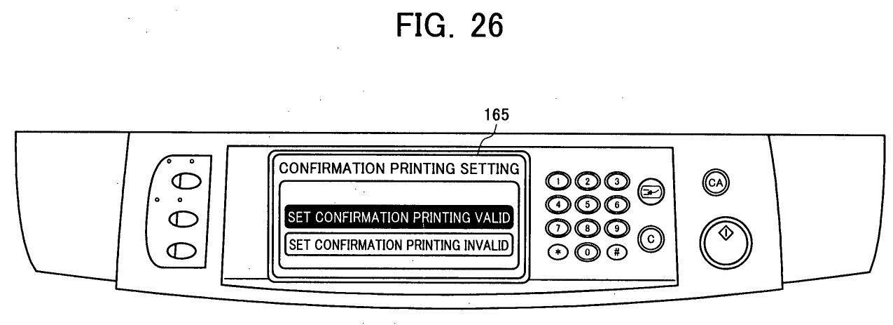

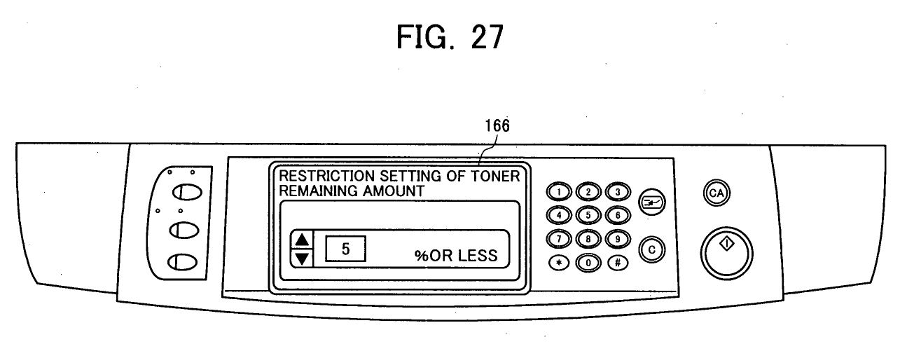

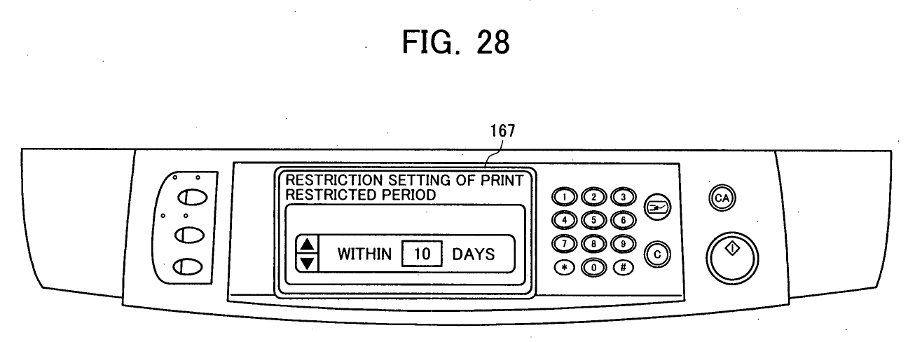

When the user presses OK on the display screen 164 of FIG. 25, the display is shifted to a display screen 165 of FIG. 26 to allow the user to select the subsequent printing method of whether to set the confirmation printing to be valid and perform printing after applying optimum output characteristics to the image data, to set the confirmation printing to be invalid and print the held image data directly, or to delete the held data. In addition, it is possible to display the display screens 166 and 167 on which the restriction setting of the toner remaining amount or the restriction setting of the print restricted period is performed as shown in FIGS. 27 and 28. It is also possible to display a setting of whether to perform the confirmation printing automatically.

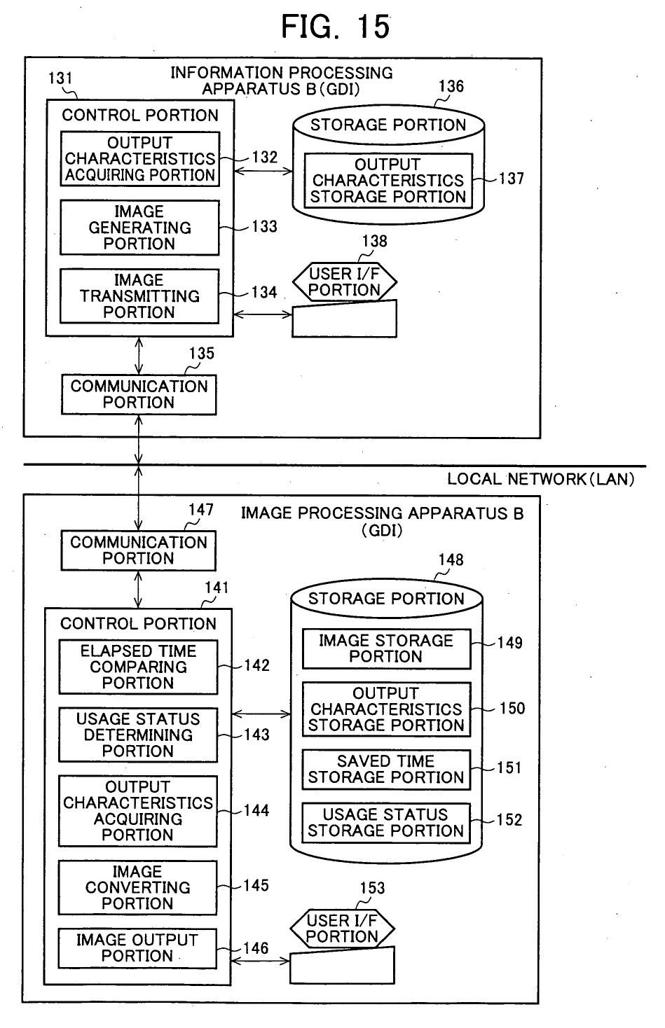

FIG. 15 is a diagram for explaining another exemplary apparatus configuration of the information processing apparatus and the image processing apparatus in the embodiment 2 more specifically.

The information processing apparatus B includes a control portion 131, a communication portion 135, a storage portion 136, and a user I/F portion 138 as shown in FIG. 15. The control portion 131 includes an output characteristics acquiring portion 132, an image generating portion 133, and an image transmitting portion 134. The storage portion 136 includes an output characteristics storage portion 137.

The user I/F portion 138 is a screen on which a user selects a printing setting of document data to be printed and is a mechanism for sending a print data generation command and a printing setting to the control portion. In a case where the user desires to save print data in the image processing apparatus without printing the print data by the image processing apparatus, it is possible to perform a setting of hold printing with the use of the display screen 90 as shown in FIG. 16. This makes it possible to cause the storage portion in the image processing apparatus to save the print data generated by the information processing apparatus. In a case where the setting of hold printing is performed in the printing setting, it is also possible to set a password to the print data as shown on the display screen 70 of FIG. 17 and to protect the print data using the password.

The communication portion 135 allows the image processing apparatus B and the information processing apparatus B to communicate with each other through a network such as a LAN and is capable of transmitting/receiving various data. A communication portion 147 similar to the communication portion 135 of the information processing apparatus B is also provided in the image processing apparatus B.

The storage portion 136 is storage means such as a ROM or a RAM and saves output characteristics of color information previously acquired by the information processing apparatus B from the image processing apparatus B. The output characteristics vary by the usage status or with elapse of time and are set so as to allow a printed matter to be output in an optimum color tone in each case. For example, the storage portion 136 saves color information of cyan, magenta, yellow, and black as the output characteristics as shown in FIG. 20. In a case where a value of cyan in the output characteristics is lower than a reference value, the tone of cyan in image data to be formed is set to be low by the control portion 131, and in a case where a value of magenta is higher than a reference value, the tone of cyan in image data is set to be high. The reference value is set inherent in the image processing apparatus as shown in FIG. 20.

The control portion 131 generates print data, makes a command to transmit the print data, acquires output characteristics, generates an image, and makes a command to transmit the image based on a print command received from the user I/F portion 138.

The information processing apparatus B generates image data based on document data and performs color adjustment of the image data in consideration of information of the output characteristics previously acquired in the storage portion 136. After the color adjustment, the image data and the printing setting (password setting and hold setting) are transmitted as print data to the image processing apparatus B.

The image processing apparatus B includes a control portion 141, a communication portion 147, a storage portion 148, and a user I/F portion 153 as shown in FIG. 15. The control portion 141 includes an elapsed time comparing portion 142, a usage status determining portion 143, an output characteristics acquiring portion 144, an image converting portion 145, and an image output portion 146. The storage portion 148 includes an image storage portion 149, an output characteristics storage portion 150, a saved time storage portion 151, and a usage status storage portion 152.

The image storage portion 149 of the storage portion 148 saves (holds) image data obtained by applying the output characteristics of the image processing apparatus to print data from the information processing apparatus A or image data from the information processing apparatus B. The output characteristics storage portion 150 saves information of the color that is set in the image processing apparatus when the image data is held. For example, it is possible to set values from 0 to 255 as shown in FIG. 20, and when the color is set to be high, the deep color is output at the time of printing the image data by the image processing apparatus.

The saved time storage portion 151 saves a time stamp when the image data was held and a setting of a period in which a print restriction is imposed. For example, the time stamp and the print restricted period are saved in a format as shown in FIG. 20. The usage status storage portion 152 saves the usage status such as the output frequency (usage frequency) or the toner remaining amount at the time when image data was held and temperature and humidity at an installation position of the image processing apparatus, and a restriction setting of each item. The restriction setting is a parameter in which a restriction is set such that the confirmation printing is performed if a change amount in the output frequency or the toner remaining amount is larger than the value. For example, as shown in FIG. 19, the number of times of printing another printed matter until then is saved as the output frequency and a ratio of the toner remaining amount such as 50% is saved as the toner remaining amount.

The control portion 141 performs processing of calculating/comparing elapsed time, processing of confirming a usage status, processing of acquiring output characteristics, processing of converting image data, and processing of outputting an image.

The elapsed time comparing portion 142 performs the processing of calculating/comparing elapsed time. Elapsed time from a point when the image data was held to a current point is derived and the elapsed time and a print restricted period that has been set are compared to determine whether or not the elapsed time exceeds the print restricted period. The elapsed time comparing portion 142 corresponds to a period calculating portion of the present invention that calculates a saved period from a point when the image data was saved to a point when print instruction was given.

The usage status determining portion 143 performs the processing of determining the usage status of the image processing apparatus B. At the determination processing, whether or not a usage status when the image data was held and a current usage status are largely changed is detected. For example, in a case where the printing frequency at the time of holding the image data is 1000 times and the current printing frequency is 10000 times, a change amount in the printing frequency is an increase by 9000 times. When the value is collated with the restriction setting of FIG. 19, a limit value is 1000 times or less of output frequency (that is, printing frequency) in a list of restriction settings of FIG. 19. In the case of exceeding the limit value, it is determined that the usage status is changed. In the above-described example, a change amount in the output frequency is 1000 times or more, it is determined that the usage status is largely changed.

The output characteristics acquiring portion 144 performs the processing of acquiring output characteristics. This is processing to acquire the output characteristics of the image processing apparatus B that have been saved at the time of holding from the storage portion 148. The image converting portion 145 performs the processing of converting image data. This is processing to delete the previous output characteristics from the image data that has been previously held and to apply the current output characteristics of the image processing apparatus to the image data from which the previous characteristics have been removed.

The image output portion 146 performs the processing of outputting an image. It is determined whether to print only a specified part, for example, only a front cover of the image data or to print all of the pages to perform printing. For example, an operation is performed such that if the usage status is largely changed when the processing of confirming the usage status is performed, only a page of the image data is printed, and if it is determined that there is no large change, all of the pages are printed.

In this example, the image processing apparatus A and the image processing apparatus B are cited as image processing apparatuses having different control portions. The image processing apparatus A applies the output characteristics to print data transmitted from the information processing apparatus to convert into image data and thereafter saves the image data. The image processing apparatus B saves the image data received from the information processing apparatus in the storage portion without converting.

The user I/F portion 153 is an interface in which a user instructs printing from the display screen 160 as shown in FIG. 21 at the time of printing the held image data. In a case where the held image data is printed on the side of the image processing apparatus B, a list of print jobs as shown in FIG. 21 is firstly displayed on the display screen 160. When the user selects one of the displayed jobs, the display is shifted to the display screen 161 as shown in FIG. 22. When “a. doc” is selected on the display screen 160 of FIG. 21, the display screen 161 of FIG. 22 enables selection of printing or deleting of the held image data. In a case where the user selects print, whether to delete or save the data after the print is selectable.

In a case where confidential printing is set to print data in the information processing apparatus B, a password is requested on the display screen 162 as shown in FIG. 23 before printing. In a case where the confirmation printing is executed based on the usage status of the image processing apparatus B and the elapsed time after holding, the user is prompted to confirm whether a printed matter is output in a correct color on the display screen 163 as shown in FIG. 24. When “direct print” is selected here, the specified image data is directly printed without performing the confirmation printing, and when “print after color adjustment” is selected, the confirmation printing for a page or the like is performed and the display screen 164 for confirmation is displayed as shown in FIG. 25.

When the user presses OK on the display screen 164 of FIG. 25, the display is shifted to the display screen 165 of FIG. 26 to allow the user to select the subsequent printing method of whether to set the confirmation printing to be valid and perform printing after applying optimum output characteristics to the image data, to set the confirmation printing to be invalid and print the held image data directly, or to delete the held data. In addition, it is possible to display the display screens 166 and 167 on which the restriction setting of the toner remaining amount or the restriction setting of the print restricted period is performed as shown in FIGS. 27 and 28. It is also possible to display a setting of whether to perform the confirmation printing automatically.

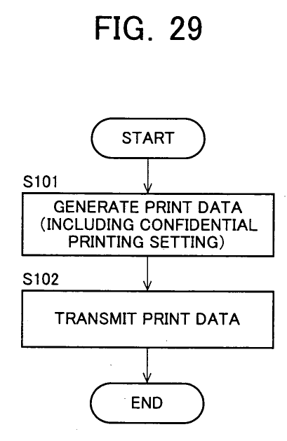

Flowcharts of FIGS. 29 to 34 show exemplary processing of the image processing apparatuses and the information processing apparatuses concerning this embodiment.

FIG. 29 shows an example of processing when printing is instructed in the information processing apparatus A. In FIG. 29, for example, in a case where a user instructs printing in the information processing apparatus A, print data is generated. If a confidential printing setting is applied from the user I/F portion 105 at this time, the setting is added to the print data (step S101). In this case, such a setting is also added in the case of hold printing in which no password is set. Subsequently, the information processing apparatus A transmits the generated print data to the image processing apparatus A (step S102).

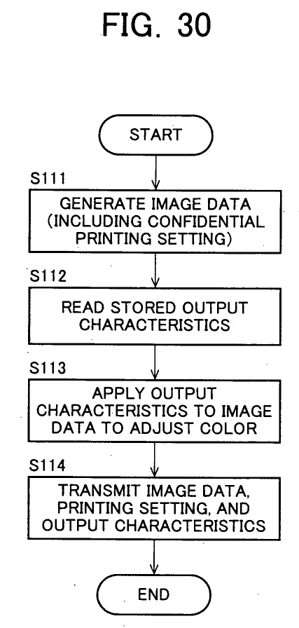

FIG. 30 shows an example of processing when printing is instructed in the information processing apparatus B. When print instruction is received in the information processing apparatus B, image data is generated (step S111). Subsequently, the output characteristics that have been previously acquired from the image processing apparatus B and stored in the storage portion is read (step S112). Then, a color of the image data is adjusted in consideration of the read output characteristics. That is, the output characteristics are applied to the generated image data and the color is adjusted (step S113). Finally, the image data, the printing setting (hold printing setting and confidential printing setting), and the output characteristics used for the color adjustment are transmitted to the image processing apparatus B (step S114).

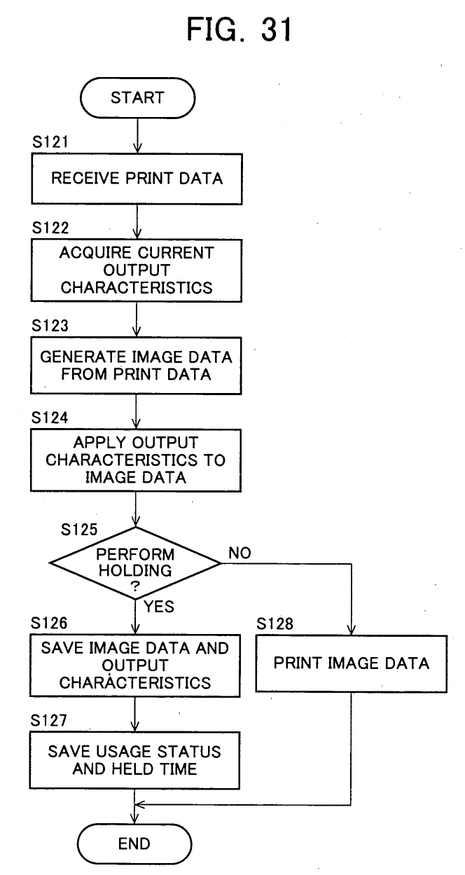

FIG. 31 shows an example of hold processing when the image processing apparatus A receives print data from the information processing apparatus A.

For example, in a case where print data is transmitted from the information processing apparatus A, the image processing apparatus A receives the print data from the information processing apparatus A (step S121) and acquires the output characteristics of the image processing apparatus A at that time (step S122). Subsequently, image data is generated based on the print data (step S123) and the color of the image data is adjusted with the use of the output characteristics acquired at step S122. That is, the output characteristics are applied to the image data (step S124).

Then, the information processing apparatus A determines whether the hold printing setting is applied to the received print data (step S125). In this case, it is assumed that setting information of both the hold printing in which no password is required and the confidential printing in which a password is required is determined as the hold printing setting. In a case where the hold printing setting is applied to the print data, the image data (including the hold printing setting) and the output characteristics are saved in the storage portion (step S126) and further the time when the image data was held and the usage status are saved in the storage portion (step S127). In a case where no hold printing setting is applied to the print data, the image data is directly printed (step S128).

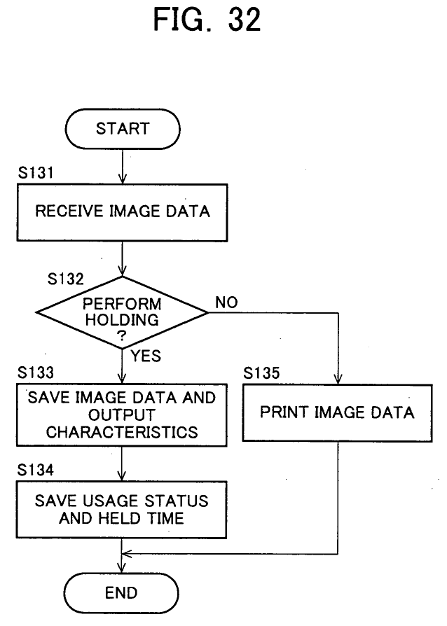

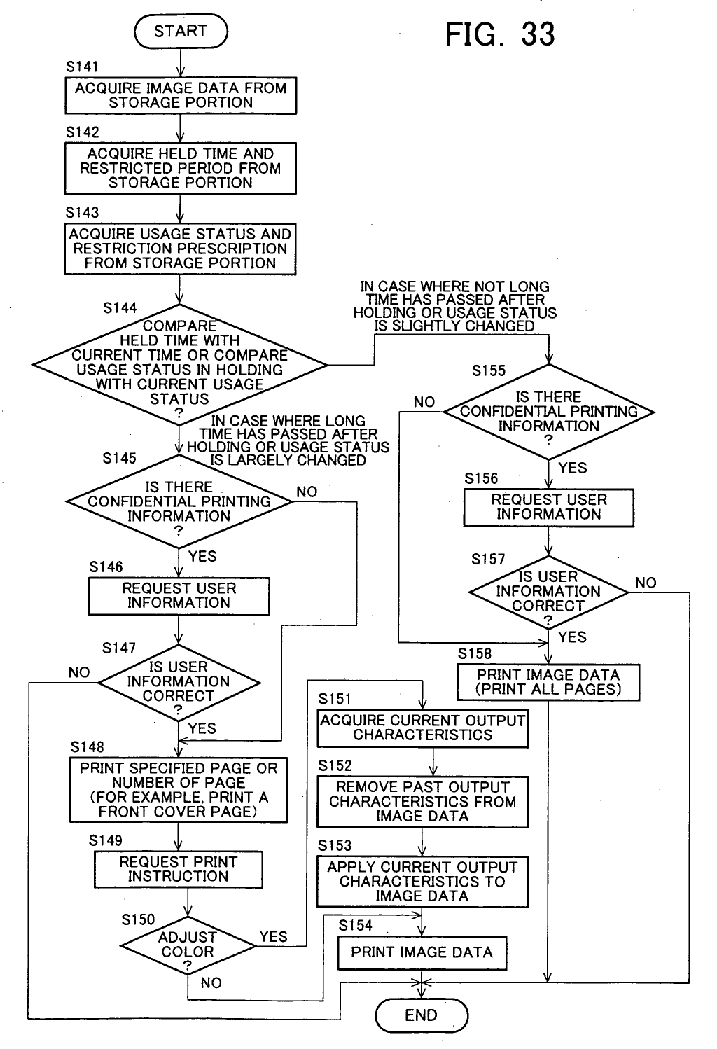

FIG. 32 shows an example of hold processing when the image processing apparatus B receives print data from the information processing apparatus B.

For example, in a case where data is transmitted from the information processing apparatus B, the image processing apparatus B receives image data together with the output characteristics and the printing setting from the information processing apparatus A (step S131). Subsequently, whether the hold printing setting is included in the printing setting, that is, whether the hold printing is performed is determined (step S132). In a case where the hold printing setting is included in the printing setting, the image data (including the hold printing setting) and the output characteristics are saved in the storage portion (step S133) and further the usage status of the image processing apparatus and the held time are saved in the storage portion (step S134). In a case where no hold printing setting is applied to the print data, the image data is directly printed (step S135).

FIG. 33 shows an example of printing processing of saved (held) image data in a case where the confirmation printing is previously set to be valid on the screen as shown in FIG. 26 in the image processing apparatuses A and B. In the printing processing of the held data, the similar processing is performed in both the image processing apparatuses A and B.

In FIG. 33, for example, in a case where a user selects held image data on the screen as shown in FIG. 21 and selects print on the screen of FIG. 22, the image processing apparatus acquires the image data from the storage portion (step S141) The held time and the print restricted period are acquired and further the usage status and the restriction prescription are acquired from the storage portion similarly (steps S142 and S143).

Subsequently, the held time and the current time are compared to determine whether the period from the held time to the current time exceeds the print restricted period, or to compare the previous usage status and the current usage status to determine-whether a difference between the usage status at the time of holding and the usage status at present satisfies the restriction setting (step S144). In a case where it has elapsed for a long time after the elapsed time after holding exceeded the print restricted period, or in a case where it is determined that the difference of the usage status does not satisfy the restriction prescription and the change is large, the procedure proceeds to the confirmation printing in which a specified page, for example, only a page is printed.

In this embodiment, whether to print only a part of pages (for example, a page) of the image data or to print all of the pages of the image data is determined based on a change of a predetermined characteristic amount from a point when the image data was held to a point when printing was instructed. As the example above, any or both of the saved period from a point when the image data was saved to a point of print instruction and the usage status of the image processing information is applicable to the characteristic amount. The usage status may be all, any one, or a plurality of a change amount in the toner remaining amount, temperature, and humidity.

In FIG. 33, at the processing of the confirmation printing, whether the confidential printing setting is applied to the image data at the time of holding the image data, that is, whether there is confidential printing information is determined (step S145), and in a case where the confidential printing setting is applied to the image data, user information (password) is requested (step S146). For example, a password is requested by the display screen 162 as shown in FIG. 23.

When the user inputs a password, the image processing apparatus determines whether the input password is matched with a password that has been previously set, that is, whether the user information is correct (step S147). When the passwords are matched, a previously specified page or number of page is printed (step S148). The specified page may be a front cover page. Subsequently, a request to confirm the color of a printed matter and a request of the print instruction are given as shown in FIGS. 24 and 25 (step S149). When the passwords are not matched, printing of the image data is not performed.

Alternatively, in a case where the confidential printing setting is not applied to the image data at the time of holding, a previously specified page or number of page, for example, only a page is printed (step S148) and a request to confirm the color of a printed matter and a request of the print instruction are given as shown in FIGS. 24 and 25 (step S149). The request of the print instruction causes the user to select on the screen as shown in FIG. 24 whether to perform printing after adjusting the color or to perform printing with the current setting. In a case where “print after color adjustment” is selected (YES at step S150), the image processing apparatus acquires the current output characteristics (step S151) and removes the past output characteristics from the image data (step S152) Subsequently, the color tone of the image data from which the output characteristics have been removed is adjusted in consideration of the output characteristics acquired at step S151. That is, the current output characteristics are applied to the image data (step S153). Then, all of the pages of the image data are printed (step S154). Alternatively, in a case where “print after color adjustment” is not selected and “print with current setting” is selected at step S150, all of the pages of the image data are printed without adjusting the color of the image (step S154).

In a case where the elapsed time after the image data was held does not exceed the print restricted period at step S144, that is, in a case where it is determined that the elapsed time after holding is less or it is determined that the difference of the usage status satisfies the restriction setting and the change is small, whether the confidential printing setting is applied to the image data at the time of holding, that is, whether there is confidential printing information is determined (step S155). In a case where the confidential printing setting is applied to the image data, a password is requested to the user as user information (step S156).

When the user inputs a password on the display screen 162 as shown in FIG. 23, the image processing apparatus determines whether the input password is matched with a password that has been previously set in the image processing apparatus, that is, whether the user information is correct (step S157). When the passwords are matched, all of the pages of the image data are directly printed (step S158). When the passwords are not matched, the processing is finished without performing printing. Alternatively, in a case where the confidential printing is not set to the image data at step S155, all of the pages of the image data are directly printed (step S158).

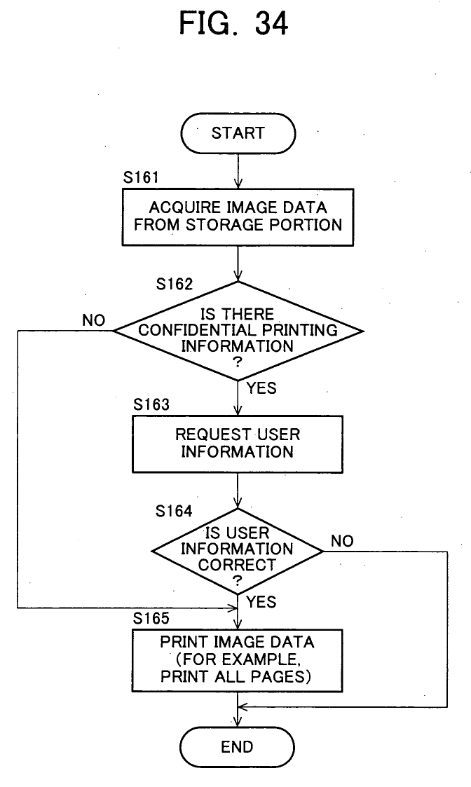

FIG. 34 shows an example of printing processing of held data in a case where the confirmation printing is previously set to be invalid on the display screen as shown in FIG. 26 in the image processing apparatuses A and B. In the printing processing of the held data, the similar processing is performed in both the image processing apparatuses A and B.

In FIG. 34, for example, in a case where a user selects the held image data on the display screen 160 as shown in FIG. 21 and selects print on the display screen 161 of FIG. 22, the image processing apparatus acquires the selected image data from the storage portion (step S161). Subsequently, whether the confidential printing setting is applied to the image data at the time of holding the image data, that is, whether or not there is confidential printing information is determined (step S162).

In a case where the confidential printing setting is applied to the image data, user information (password) is requested on the display screen 162 as shown in FIG. 23 (step S163). When the user inputs a password to the display screen 162, the image processing apparatus determines whether the input password is matched with a password that has been previously set in the image processing apparatus, that is, whether the user information is correct (step S164). When the passwords are matched, all of the pages of the image data are directly printed (step S165). When the passwords are not matched, the processing is finished without performing printing. Alternatively, in a case where the confidential printing is not set to the image data at step S162, all of the pages of the image data are directly printed (step S165).

Note that, although the processing shown in the flowchart has been described with reference to the case of performing in the image processing apparatus in this embodiment, the processing may be provided by software.

According to the present invention, following effect can be obtained.

According to the present invention, it is possible to provide an image processing apparatus and an image processing method capable of preventing that, when printing image data once saved in the image processing apparatus in accordance with subsequent operation input, a color of a printed matter becomes different and a printed matter having a different color is output due to a change in output characteristics between at the time of saving and at the time of printing.

1. An image processing apparatus having a function of printing image data saved in the image processing apparatus in accordance with print instruction given by predetermined operation input to the image processing apparatus, comprising:
output characteristics comparing means for comparing, when print instruction for the image data saved in the image processing apparatus is given, output characteristics to which a characteristics value to be used for printing is set, the output characteristics comparing means comparing output characteristics of the image processing apparatus when the image data was saved with output characteristics of the image processing apparatus when the print instruction was given, wherein
when it is determined from a result of comparison by the output characteristics comparing means that there is a difference of a predetermined value or more in the compared output characteristics, image data to be printed is regenerated based on the output characteristics of the image processing apparatus when the printing was instructed.

2. The image processing apparatus as defined in claim 1, wherein
the output characteristics comparing means compares the output characteristics in a case where a predetermined time or more has passed from a point when the image data was saved in the image processing apparatus to a point when the printing was executed.

3. The image processing apparatus as defined in claim 1, wherein
the output characteristics comparing means compares the output characteristics in a case where a predetermined amount or more of toner has been used for printing from a point when the image data was saved in the image processing apparatus to a point when the printing was executed.

4. The image processing apparatus as defined in claim 1 having a function of performing printing with a plurality of colors of toner, wherein
when the output characteristics comparing means compares output characteristics and even a single color has a difference of a predetermined value or more in output characteristics among output characteristics corresponding to each of the plurality of colors of toner, processing of regenerating the image data to be printed is performed, the image data to be regenerated being image data corresponding to a toner having a difference of a predetermined value or more in the output characteristics.

5. The image processing apparatus as defined in claim 1 having a function of performing printing with a plurality of colors of toner, wherein
when the output characteristics comparing means compares the output characteristics and even a single color has a difference of a predetermined value or more in output characteristics among output characteristics corresponding to each of the plurality of colors of toner, processing of regenerating the image data to be printed is performed, the image data to be regenerated being all image data corresponding to all toners.

6. An image processing method executed by an image processing apparatus having a function of printing image data saved in the image processing apparatus in accordance with print instruction given by predetermined operation input to the image processing apparatus, comprising:
an output characteristics comparing step of comparing, when print instruction for the image data saved in the image processing apparatus is given, output characteristics of the image processing apparatus when the image data was saved with output characteristics of the image processing apparatus when the print instruction was given with respect to output characteristics to which a characteristics value to be used for printing is set; and
a step of regenerating image data to be printed based on the output characteristics of the image processing apparatus when the printing was instructed in a case where it is determined from a result of comparison at the output characteristics comparing step that there is a difference of a predetermined value or more in the compared output characteristics.

7. An image processing apparatus having a function of printing image data saved in the image processing apparatus in accordance with print instruction given by predetermined operation input to the image processing apparatus, wherein
when print instruction for the image data saved in the image processing apparatus is given, whether to print only a part of pages of the image data or to print all pages of the image data is decided based on a change in a predetermined characteristic amount from a point when the image data was saved to a point when the print instruction was given.

8. The image processing apparatus as defined in claim 7 having a period calculating portion that calculates a saved period of the image data from a point when the image data was saved to a point when the print instruction was given, wherein
the saved period calculated by the period calculating portion is used as the characteristic amount, and only a part of pages of the image data is printed in a case where the saved period exceeds a period previously set in the image processing apparatus, and all pages of the image data are printed in the case of not exceeding.

9. The image processing apparatus as defined in claim 7, wherein
a change amount in a predetermined usage status of the image processing apparatus from a point when the image data was saved to a point when the print instruction was given is used as the characteristic amount, and only a part of pages of the image data is printed in a case where the change amount in the usage status exceeds a set value previously set in the image processing apparatus, and all pages of the image data are printed in the case of not exceeding.

10. The image processing apparatus as defined in claim 9, wherein
the change amount in the usage status is a change amount in a toner remaining amount of the image processing apparatus.

11. The image processing apparatus as defined in claim 9, wherein
the change amount in the usage status is a change amount in temperature in a place where the image processing apparatus is installed.

12. The image processing apparatus as defined in claim 9, wherein
the change amount in the usage status is a change amount in humidity in a place where the image processing apparatus is installed.

13. The image processing apparatus as defined in claim 7, wherein
a part of pages of the image data is a first page of the image data.

14. An image processing method executed by an image processing apparatus having a function of printing image data saved in the image processing apparatus in accordance with print instruction given by predetermined operation input to the image processing apparatus, comprising:
a step of detecting, when print instruction for the image data saved in the image processing apparatus is given, a change in a predetermined characteristic amount from a point when the image data was saved to a point when the print instruction was given; and
a step of deciding whether to print only a front cover page of the image data or to print all pages of the image data based on the detected change in the characteristic amount.
